(19) United States
(12) Patent Application Publication
(10) Pub. No.: US 2022/0040687 A1
(43) Pub. Date: Feb. 10, 2022

(54) Diagnostic Systems and Methods for Hemolytic Anemias and Other Conditions

(71) Applicant: KovaDx, Inc,, New Haven, CT (US)

(72) Inventors: Yaw Ofosu Ansong Jnr, Albany, CA (US); Timothy D. Adamson, New Haven, CT (US)

(73) Assignee: KovaDx, Inc., New Haven, CT (US)

(21) Appl. No.: 17/395,596

(22) Filed: Aug. 6, 2021

Related U.S. Application Data
(60) Provisional application No. 63/061,820, filed on Aug. 6, 2020.

(51) Int. Cl. B01L 3/00; G01N 35/08

(52) U.S. Cl. CPC B01L 3/50273; G01N 35/08; B01L 2400/0481; B01L 2300/0663; B01L 2400/0487; B01L 2300/0681; B01L 2300/0654

(57) ABSTRACT

An imaging system for imaging a fluid sample includes a light source configured to generate a beam of light, an angled element disposed along an optical path of the beam of light, and a sample cartridge holder configured to receive a sample cartridge and configured to hold the sample cartridge in a first position in which an imaging region of the sample cartridge is disposed along the optical path. The system further includes a sensor configured to capture the beam of light after it passes through the angled element and the imaging region of the sample cartridge. The imaging region of the sample cartridge is configured to receive the sample fluid. A sample cartridge having a cover plate and a fluidics layer is also disclosed. The fluidics layer includes an opening, a fluid channel, and an imaging region configured to receive a whole blood sample.

### PRIORITY CLAIM

The present application claims the benefit of copending U.S. Provisional Patent Application Ser. No. 63/061,820, filed Aug. 6, 2020 and entitled “Diagnostic Systems and Methods for Hemolytic Anemias and Other Conditions,” which application is incorporated herein by reference in its entirety.

### BACKGROUND

Diagnosis and monitoring of red blood cell diseases (such as sickle cell disease “SCD”) is expensive, difficult, and requires skilled personnel. There is the need for someone to develop a point of care technology that is fast, easy to use, and very affordable. Current solutions include hemoglobin (“HB”) electrophoresis, high-performance liquid chromatography (“HPLC”), microscopy-based processes, and a SICKLEDEX® test available from Streck, La Vista, Nebr. HB electrophoresis can differentiate between sickle cell trait and disease; however it is expensive and requires a skilled operator. The same can be said for HPLC. Microscopy-based tests and SICKLEDEX®, whilst affordable, cannot differentiate the various genotypes of sickle cell disease. In addition, none of the above technologies are platform technologies and they are not useful in patient monitoring.

Wide-field digital interferometry (“WFDI”) is a technique that provides quantitative measurements of optical path delays (“OPDs”) associated with optically transparent samples. The process works by recording the pattern of interference between the interaction of light with a sample (in this case the red blood cells, “RBCs”) and a mutually coherent reference wave. The process provides a quantitative phase and amplitude profile of the sample.

By way of background, U.S. Pat. No. 8,508,746, patented Aug. 13, 2013, to Duke University, is incorporated by reference herein in its entirety.

### SUMMARY

Some embodiments of the present disclosure are directed to an interferometry system including an interferometric chamber (“InCh”) as an alternative approach for recording the dynamics of transparent biological samples. In some embodiments, the system is configured to perform common-path interferometry wherein the beam is split by the InCh itself at the desired angle. As a result, no special optical elements are required in the path of the beam and interferometric alignment can be performed once, e.g., during the fabrication of the chamber, and not each time before the measurement, further simplifying the process. The system is effective for identifying hemolytic anemias, e.g., sickle cell disease and malaria, within a patient sample.

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its purpose is to present some concepts of one or more aspects in a simplified form as a prelude to the more detailed description that is presented later.

In an aspect of the disclosure, an imaging system for imaging a fluid sample is disclosed. The imaging system includes a light source configured to generate a beam of light, an angled element disposed along an optical path of the beam of light, a sample cartridge holder configured to receive a sample cartridge and configured to hold the sample cartridge in a first position in which an imaging region of the sample cartridge is disposed along the optical path, and a sensor configured to capture the beam of light after the beam of light passes through the angled element and the imaging region of the sample cartridge. The imaging region of the sample cartridge is configured to receive the sample fluid.

In another aspect of the disclosure, a sample cartridge is disclosed. The sample cartridge includes a cover plate comprising a sample fluid inlet and a fluidics layer. The fluidics layer includes an opening configured to receive a whole blood sample from the sample fluid inlet and an imaging region configured to receive the whole blood sample from the opening through a fluid channel. The sample fluid inlet, the opening, the fluid channel, and the imaging region are configured to promote a directional flow of the whole blood sample through the imaging region.

### BRIEF DESCRIPTION OF THE DRAWINGS

The appended drawings illustrate only some implementations and are therefore not to be considered limiting of scope.

FIG. 1 is a schematic diagram of an interferometric system, in accordance with aspects of the present disclosure.

FIGS. 2A-2B illustrate a side cross-sectional view and a perspective cross-sectional view of an imaging system, in accordance with aspects of the present disclosure.

FIG. 2C is a perspective view of an imaging system, in accordance with aspects of the present disclosure.

FIG. 3 is a schematic view of a portion of an imaging system, in accordance with aspects of the present disclosure.

FIGS. 4A and 4B show a perspective view and an exploded view of a sample cartridge, in accordance with aspects of the present disclosure.

FIG. 4C is a perspective view of a sample cartridge holder, in accordance with aspects of the present disclosure.

FIG. 4D shows a top view of a sample cartridge, in accordance with aspects of the present disclosure.

FIGS. 4E-4G show detailed views of a sample cartridge, in accordance with aspects of the present disclosure.

FIG. 5 illustrates a schematic view of a system to control fluid flow through a sample cartridge, in accordance with aspects of the present disclosure.

FIG. 6 illustrates a pinched segment feature of a fluidics layer, in accordance with aspects of the present disclosure.

FIG. 7 shows an exploded view of a sample cartridge, in accordance with aspects of the present disclosure.

FIG. 8 illustrates a process for fabricating a sample cartridge, in accordance with aspects of the present disclosure.

FIG. 9 illustrates a top perspective view of a cover plate of a sample cartridge, in accordance with aspects of the present disclosure.

FIG. 10 illustrates a top perspective view of a fluidics layer of a sample cartridge, in accordance with aspects of the present disclosure.

FIG. 11 shows a detailed view of an imaging region of a sample cartridge, in accordance with aspects of the present disclosure.

FIG. 12 shows a top view of a sample cartridge having a cover plate and a fluidics layer, in accordance with aspects of the present disclosure.

FIG. 13 shows a top view of a cover plate configured to accommodate electrodes, in accordance with aspects of the present disclosure.

FIG. 14 shows a top view of a fluidics layer configured to accommodate electrodes, in accordance with aspects of the present disclosure.

FIG. 15 shows a schematic view of a portion of an imaging system, in accordance with aspects of the present disclosure.

FIG. 16 shows a perspective view of an imaging system within a housing, in accordance with aspects of the present disclosure.

FIGS. 17A and 17B illustrate front and side perspective views of a housing configured to contain an imaging system, in accordance with aspects of the present disclosure.

FIGS. 18 and 19 show flow charts illustrating exemplary machine learning processes for recognizing sickled RBCs.

### DESCRIPTION

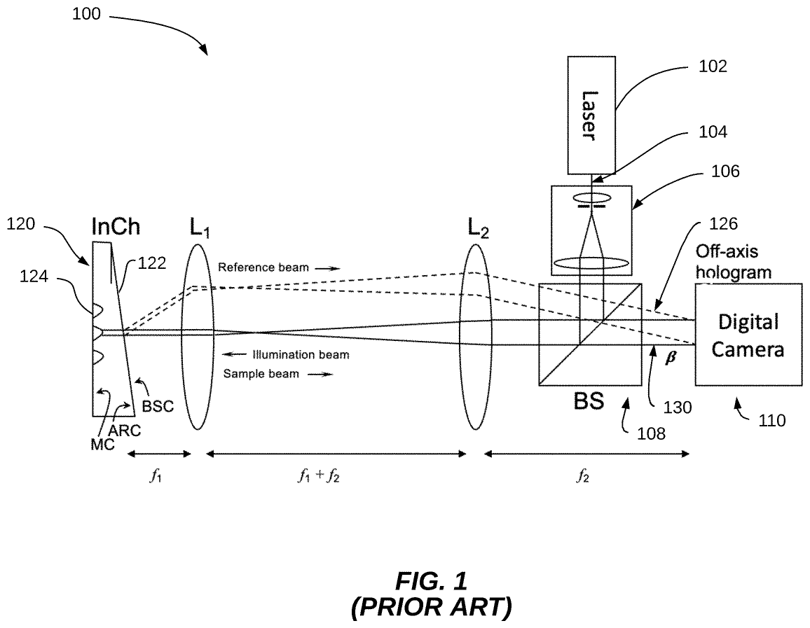

Referring to FIG. 1, an interferometric system 100 known in the art is illustrated. The system 100 includes a laser light source 102 configured to generate and emit an illumination beam 104 (e.g., a coherent beam) in a first direction such that the illumination beam passes through a spatial filter beam expander 106 and impinges on a beam splitter 108. The beam splitter 108 may reflect or otherwise redirect the illumination beam 104 in a second direction that may be substantially perpendicular to the first direction. The illumination beam 104 may then pass through one or more lenses L2, L1 before impinging on a sample holder 120.

The sample holder 120 is configured to hold a sample therein and may include a front cover slip 122 and a back cover slip 124. The front cover slip 122 is configured to allow a first portion of the illumination beam 104 to transmit therethrough where it may interact with the sample in the sample holder 120 as it propagates to or from the back cover slip 124. At least part of the first portion of the illumination beam 104 exits the sample holder 120 through the front cover slip 122 after interacting with the sample. This part of the first portion of the illumination beam 104 propagates through the system 100 as a sample beam 130 toward a sensor of a digital camera 110 where the sample pattern of interference is captured. The front cover slip is further configured to reflect a second portion of the illumination beam 104 at an angle relative to the optical axis 112. The second portion of the illumination beam 104 does not interact with the sample and is propagated through the system 100 as a reference beam 126 toward the sensor of the digital camera 110 where the reference pattern of interference is captured. Thus, the sample pattern may be compared to the reference pattern to obtain a quantitative phase and amplitude profile of the sample. Additional details regarding the system 100 are available in U.S. Pat. No. 8,508,746, patented Aug. 13, 2013, to Duke University, incorporated by reference herein in its entirety.

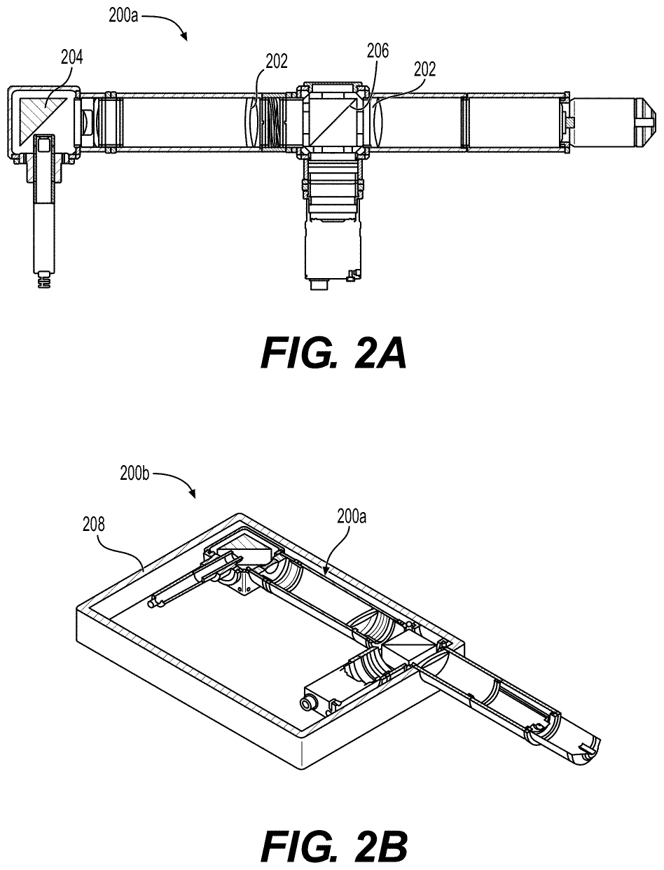

Referring now to FIGS. 2A-2C, some embodiments of the present disclosure are directed to a system for measuring concentrations of target components of whole blood. FIG. 2A illustrates a cross-sectional view of an optical system 200a configured to generate light and direct the light toward a sample (not shown) for performing interferometry. The optical system 200a includes a light source, various optical elements (e.g., lenses 202 and mirror 204), and a beam splitter 206 configured to redirect light toward a sensor for data collection or for viewing. In some embodiments, the system includes one or more components for performing interferometry. In some embodiments, the system is used to perform interferometric processes for cell culture, fertility testing, as well as diagnosis of hemolytic anemias (e.g., sickle cell disease and malaria), and non-red blood cell diseases (e.g., platelet disorders, white blood cell diseases), etc.

FIG. 2B illustrates a cross-sectional view of an assembly 200b. The assembly 200b includes a housing 208 configured to at least partially enclose the optical system 200a. FIG. 2C illustrates a perspective view of an assembly 200c. The assembly 200c includes the assembly 200b having the optical system 200a at least partially enclosed in a housing 208. The assembly 200c further includes a stage 210. The position of stage 210 may be adjustable relative to the assembly 200b so that a sample (not shown) mounted to the stage can be viewed at a variety of locations or can be viewed at an optimal location. In some embodiments, the stage 210 may be motorized.

In some embodiments, the optical system includes one or more interferometers. In some embodiments, the interferometers are configured for common-path interferometry. In some embodiments, the system includes at least one common-path interferometer. In some embodiments, the interferometer includes one or more cameras, light sources, beam splitters, light receiving modules, imaging modules, etc. In some embodiments, the system is a fully standalone device with a single board computer, a case enclosing the interferometers, one or more displays (e.g., touch screens), sensors (e.g., flow sensors), etc. In some embodiments, the system includes a non-transitory computer storage media coupled with a computing device and encoded with one or more computer programs, e.g., an artificial intelligence (“AI”) algorithm that automates the system, simplifies the diagnosis and interpretation of results, displays the results and/or a graphical user interface (“GUI”) on the screens (e.g., without the need to connect the system to additional peripherals), etc. In some embodiments, the interferometer includes a sample staging module, as will be discussed in greater detail below. In some embodiments, the system overlaps reference and sample beams, so that the same vibrations occur for both beam paths. This overlap of reference and sample beams advantageously reduces measurement errors in the phase profile associated with instability in the interferometric system, including differential vibrations or air perturbations in the interferometer arms. Thus, the setup may be used in ambient conditions and in very low-resource settings, where vibration-isolating optical tables are inaccessible.

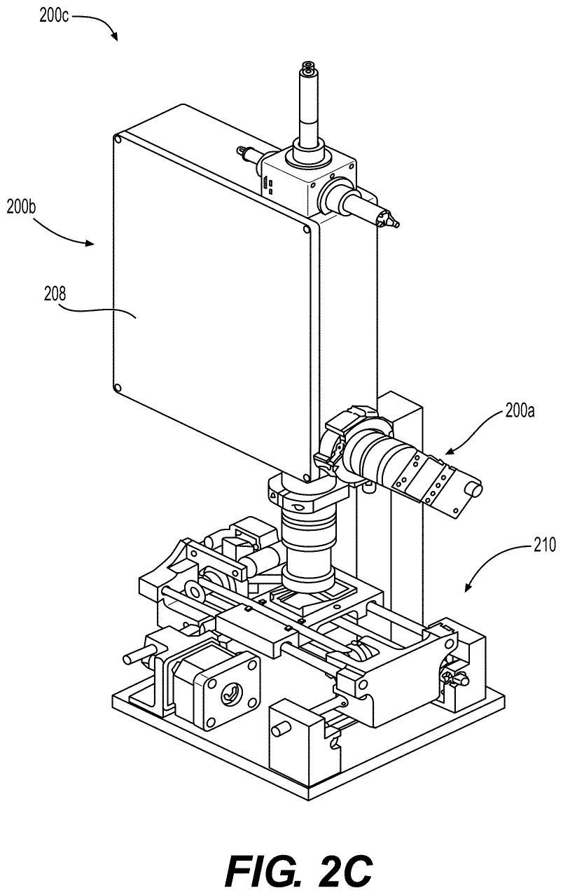

Referring now to FIG. 3, as discussed above, in some embodiments, the interferometer includes a sample staging module or stage. In some embodiments, the sample staging module 300 includes a reflective element 304 supported by a stage 302, an angled element 308, and a sample cartridge slot disposed between the reflective element and the angled element. The sample cartridge slot is configured to receive a sample cartridge 306 that contains a sample of fluid (e.g., whole blood) to be imaged using interferometry. In some embodiments, the angled element 308 is semi-reflective such that a first portion of light impinging thereon is reflected (e.g., at an angle normal to the angled surface of the element 308) while a second portion of the impinging light is transmitted through the angled element 308 where it may interact with the sample contained within the sample cartridge 306. In some embodiments, the angled element 308 is a triangular prism. In some embodiments, the angled element 308 may be a flat optical component, such as a plate or cover slip, that is disposed at an angle (e.g., non-parallel and non-perpendicular) relative to an optical path of the light impinging thereon. In some embodiments, the reflective element 304 is substantially 100% reflective such that substantially all light that reaches the reflective element 304 through the sample cartridge 306 is reflected back through the sample cartridge 306 toward the angled element 308. The reflected light may be transmitted through the angled element 308 where it travels toward a sensor for data collection. In some embodiments, as discussed above, the beam of the interferometer is split by the sample staging module 300 itself (e.g., by the angled element 308) at the desired angle.

The position of the sample staging module 300 may be adjustable. For example, the stage 302 may be moved in the positive y-direction as indicated by the arrows 310a, 310b. In some embodiments, the stage 302 may be moved in the x-, y-, and/or z-directions such that the sample cartridge inserted therein can be imaged by an interferometry system (not shown) in which the staging module 300 is included. The stage may be motorized and may be adjusted manually by a user or automatically by a motorized system. For example, the stage may be adjusted based on initial imagery collected during the interferometry process or based on results of a calibration process.

In addition to an adjustable stage, the position of the angled element 308 may be adjustable. For example, the element 308 may be moved toward the sample cartridge 306 (e.g., in the negative y-direction) as represented by arrows 312a, 312b. By moving the stage in the positive y-direction and/or moving the angled element 308 in the negative y-direction, the sample cartridge slot 306 (and thus, the sample cartridge contained therein) may be substantially sandwiched between the angled element 308 and the reflective element 304 such that air gaps between the components are minimized or eliminated. In some embodiments, the position adjustments of the angled element and/or the stage are completed during an initial calibration step that does not need to be completed each time the interferometry system is used. By eliminating the need to re-calibrate the system each time it is used, the sample staging module 300 disclosed herein may substantially improve throughput of samples through an interferometry system.

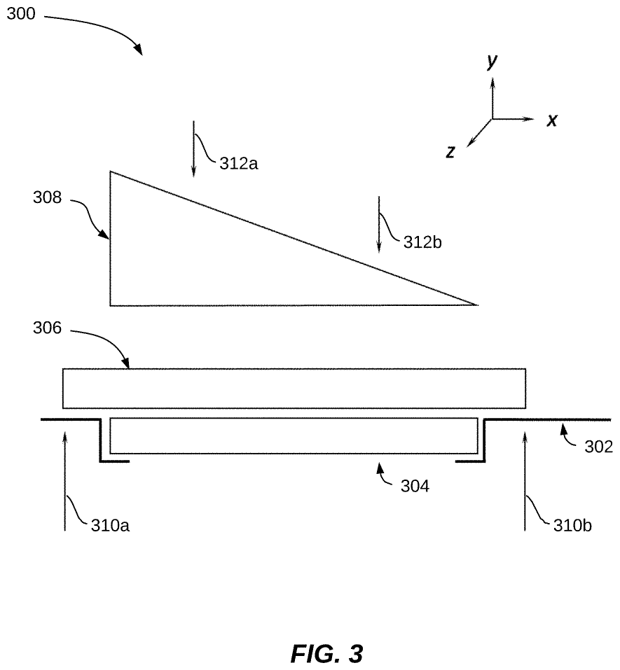

The sample cartridge 306 is configured to reversibly accept sample fluid cartridges. In some embodiments, the sample cartridges 306 configured to insert into the cartridge slot are disposable and may be a one-time use item. FIG. 4A illustrates a perspective view of an example sample cartridge 400 and FIG. 4B illustrates an exploded view of the sample cartridge 400. The sample cartridge 400 may include several layers such as, for example, a frame 402, a middle layer 404, and a top layer 406. The frame 402 may be formed from a rigid polymer material, such as PLA or ABS and may be 3D printed using a 3D printer having a resolution of at least approximately 50 μm. Alternatively, the frame 402 may be formed from a metal material using selective laser sintering (“SLS”) or other fabrication methods. The middle layer 404 and top layer 406 may be formed from polydimethylsiloxane (“PDMS”) and may include channels, ridges, baffles, ports, and other features therein to control flow of the sample into and out of the cartridge. In some embodiments, the cartridge 400 may hold up to approximately 8 μL of sample volume; however, a smaller sample of approximately 1-2 μL volume can be used for imaging. In some embodiments, the cartridge width and length dimensions may be less than approximately 30 mm. In some embodiments, the cartridge width and length dimensions may be greater than approximately 20 mm. In some embodiments, the fully assembled maximum thickness of the cartridge is between about 1 mm and about 5 mm. In some embodiments, the thickness is between approximately 1 mm and approximately 1.5 mm.

An example embodiment of a sample cartridge slot frame 408 is illustrated in FIG. 4C. The slot frame 408 includes a sample cartridge slot 410 that is configured to receive the sample cartridge 400 therein. The slot frame 408 may hold the sample cartridge with a friction fit. The slot 410 may include guides 412, rails, or other geometry to assist the sample cartridge sliding into place and seating properly within the slot frame 408 for optimal imaging. In some embodiments, the thickness dimension of the sample cartridge slot is between about 1 mm and about 5 mm. In some embodiments, the sample cartridge slot has a thickness between about 2.5 mm and about 3.5 mm. In some embodiments, the sample cartridge slot has a thickness of about 3 mm. In some embodiments, once a cartridge is inserted, either the stage/reflective element is moved up or the angled element is moved down to remove air contact between the optical pieces and the cartridge. In some embodiments, the system includes one or more components configured to automatically replace sample fluid cartridges in the sample cartridge slot, as will be discussed in greater detail below.

As discussed above with respect to FIGS. 4A-4B, the sample fluid cartridges may be composed of a framing portion (e.g., frame 402) and a fluidics portion (e.g., top and middle layers 406, 404). The sample fluid cartridges can be of any suitable size to fit in the sample cartridge slot and provide a sample for measurement by the interferometer. In some embodiments, the fluidics portions of sample cartridges include one or more fluidic channels. The height (e.g., in the y-direction) of the one or more fluidic channels may be selected such that it is larger than cells and other components contained within the sample fluid. The height may also be selected such that it is small enough to keep the cells and other components within a threshold distance of a focal plane for clear imaging. For example, in some embodiments, the one or more fluidic channels have a height of about 90-110 μm. In some embodiments, the one or more fluidic channels have a height of about 100 μm. In some embodiments, the one or more fluidic channels are in fluid communication with a fluid flow inlet and fluid flow outlet. In some embodiments, the fluidic channels, inlets, and outlets are configured and sized to accommodate a desired flow volume of sample. In some embodiments, the fluidics portion of the sample fluid cartridges may also be configured to receive a sample carrier fluid, e.g., phosphate-buffered saline (“PBS”). The PBS may flow into and out of the sample cartridges at a desired flow rate, while also preventing clotting and/or blockage of the channels by the sample. In some embodiments, the sample fluid cartridges have a fluid volume capacity of about 0.5 μL, 1 μL, 2 μL, 3 μL, 4 μL, 5 μL, 6 μL, 7 μL, 8 μL, 9 μL, or greater than 10 μL of whole blood. In some embodiments, the system incorporates microfluidic cell separation with the sample, as will be discussed in greater detail below. In some embodiments, the sample fluid cartridge is composed of any suitable combination of materials. In some embodiments, the sample fluid cartridge is composed of polymer, e.g., polydimethylsiloxane (“PDMS”), polylactic acid (“PLA”), acrylonitrile butadiene styrene (“ABS”), etc., glass, wood, metal, or combinations thereof. In some embodiments, the sample fluid cartridges are 3D printed. In some embodiments, the 3D printer has a resolution of at least approximately 50 μm.

Referring to FIGS. 4D-4G, an example sample cartridge 420 is illustrated. FIG. 4D shows a top-down view of the sample cartridge 420 having a frame 422 and a fluidics portion 424. The fluidics portion 424 includes a fluidics design 426 configured to direct one or more of a sample fluid and/or a carrier fluid. FIG. 4E illustrates a detailed view of the fluidics design 426 having a separation channel followed by a concentration unit. The concentration units are shown in closer detail in FIGS. 4F and 4G. The fluidics design 426 may be particularly advantageous for use with cell sorting, as will be discussed in greater detail below.

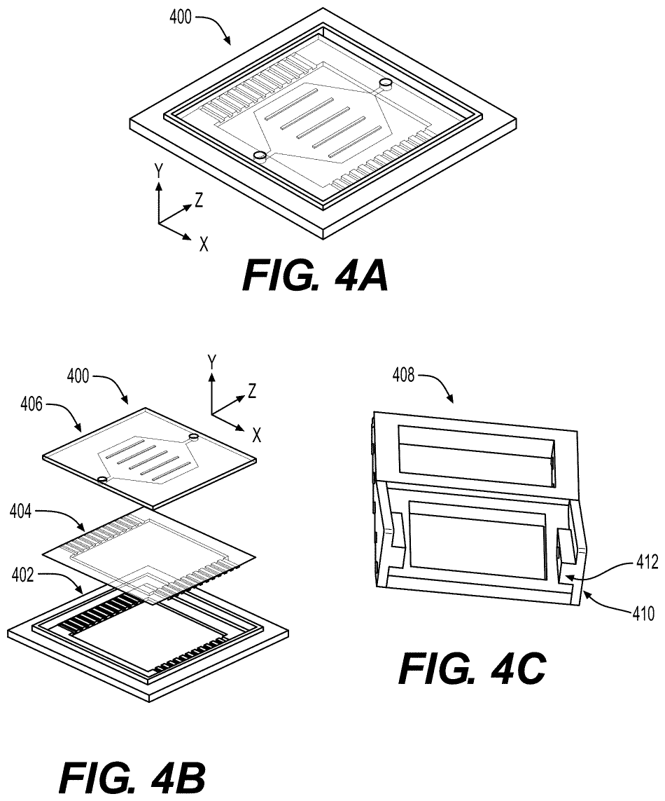

Referring now to FIG. 5, a sample flow system 500 is illustrated. The system 500 includes a syringe pump controller 502 operably coupled with a syringe pump 504. The syringe pump 504 may include one or more of a sample syringe 506 and a PBS syringe 508 that may be fluidly coupled with a sample cartridge 510. The sample cartridge 510 includes at least one fluid inlet 512, a sample separation channel 514 where sample and PBS fluids may be combined and imaged, and a fluid outlet 516. The fluid outlet 516 may be fluidly coupled with a waste collection container 518. The sample separation channel 514 may be the focus of an interferometry system, such as system 200c discussed above, and the sample flowing through separation channel 514 may be imaged for data collection.

The cartridge 510 may include one or more fluidic connectors that may be attached to the cartridge. In some embodiments, an additional slab of PDMS (not shown) is attached on or just over the inlet 512 and outlet 516 to the cartridge. In some embodiments, the syringe pump may be a Fusion 4000 pump available from Chemyx Inc., Stafford, Tex. or any syringe pump configured to control fluid flow at two different flow rates. Alternatively, a sample loading system may include two different syringe pumps, e.g., two Fusion 200 pumps also available from Chemyx Inc. The system 500 further includes syringes, tubing to connect syringe to device depending on the type of syringe, and tubing (e.g., from Fluigent, North Chelmsford, Mass. or McMaster-Carr, Santa Fe Springs, Calif.), metal connectors to connect tubing to system, etc.

As discussed above, in some embodiments, an interferometry system may be operated without first separating the cells in a sample. In some embodiments without cell pre-sorting, the sample fluid cartridges, such as cartridge 400 shown in FIG. 4A, may be used to hold the sample fluid while interferometry imaging is completed. In some embodiments, one or more machine learning programs, e.g., AI algorithms, may receive the collected interferometry data and process the data to differentiate what is a target component (e.g., red blood cell), and what is not. The program may further differentiate between normal, healthy RBCs and unhealthy RBCs. The program may be designed to identify a variety of healthy or unhealthy cells within the sample based on characteristics such as size, shape, or other detectable features. Details of an exemplary machine learning process for recognizing sickled RBCs are discussed below at an appropriate juncture in the present disclosure.

In some exemplary embodiments, a drop of blood sample is diluted in prefilled tubes (e.g., Eppendorf tubes with prefilled PBS) prior to being loaded into a cartridge for imaging. In some embodiments, the undiluted sample is loaded into the cartridge and the cartridge is inserted into the sample cartridge slot. In some embodiments, the undiluted sample is then imaged. The cartridge is then removed, and the system is ready to receive the next cartridge for imaging. This exemplary embodiment is advantageous in that it uses less time than traditional interferometry processes, is simple to use, and does not require access to expensive lab equipment. Additional fluidic components can be eliminated or reduced, and the user does not need to replace fluids and waste product containers. Thus, the need to prime channels or clean tubing, e.g., via alcohol or deionized “DI” water rinse, may also be avoided. The need for additional fluidic control programming in the interferometry system, such as sensing and indicating to an operator that the waste container is full, a reagent is running low, a pump requires priming, etc., may also be reduced.

In some sample preparation methods, the target components within the sample fluid are sorted prior to being imaged. In some embodiments, the components are sorted within the system itself. There are several approaches to conducting cell separation, many involving external forces, such as electric field, acoustics, centrifugal, etc. In some embodiments, hydrodynamic separation based on size is performed in order to keep the device simple, e.g., according to Yamada, et al. (Anal. Chem 2004). Such a method may be used to separate and collect cells for imaging.

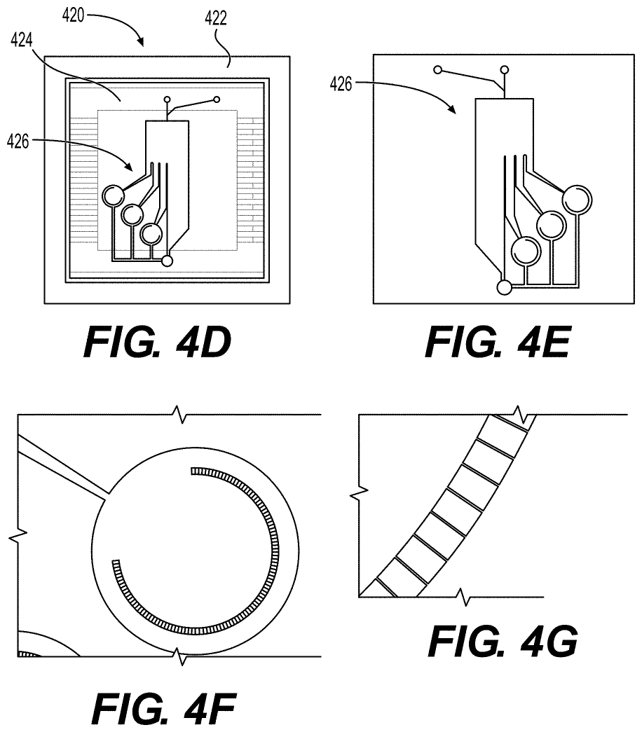

FIG. 6 illustrates a detailed view of a sample cartridge 600 configured to separate components (e.g., cells) within a sample fluid. The cartridge 600 includes a first fluid channel 602 configured to receive a sample fluid and a second fluid channel 604 configured to receive a carrier fluid. The first and second fluid channels converge at a pinched segment before entering a broadened segment. As the carrier fluid and sample fluid enter the pinched segment, particles (e.g., cells), the distance between a top wall of the pinched segment and the center of each type of cell is dependent on the cell type. Thus, the distance for a white blood cell is different than the distance for a red blood cell or a platelet. Once the cells flow into the broadened segment, and if the flow remains laminar, the different cell types will follow a different flow trajectory. The separated cells may be easier to identify and differentiate during processing of the collected images.

In some exemplary embodiments, 1-2 drops of blood are prepared. A pump is provided with at least two different channels: one for blood sample, and one for PBS. In some embodiments, the blood samples were provided to prefilled Eppendorf tube and mix (dilution of 1:10 in PBS). The samples were loaded into a syringe, e.g., 100 μL syringe, and syringe placed into the syringe pump. In some embodiments, the fluidic system is primed. In some embodiments, the fluidic system is connected to a cartridge. The syringe pump/fluidic system then conducts the cell separation of the blood sample. Cells are then flowed through the cartridge where they are imaged by the interferometer as discussed above. In some embodiments, the sample is flowed through the system for about 1-5 mins. The fluidic system may then be unplugged. This exemplary embodiment is advantageous in that the system can be fully automated. Further, because the cells are separated, there is reduced need for algorithms to identify cells in the sample, making looking at cells easier.

In one exemplary embodiment of the present disclosure, the following materials were provided:
3D printer;
ABS or PLA ink for 3D printer;
PDMS kit (e.g., Sylgard 184 Silicone Elastomer Kit);
Degassing chamber and/or vacuum source;
Glass slide (e.g., slide having an area >25 mm2);
Petri dish sized to accommodate the glass slides;
Plasma treatment equipment (O2 plasma, 100 W);
tridecafluoro-1,1,2,2-tetrahydrooctyl trichlorosilane (fluorinated silane, available from Gelest, Inc., Morrisville, Pa.);
Anhydrous ethanol (EtOH);
Distilled, deionized water (DI water);
Mask photolithography negative on silicon using photoresist;
Punch (0.5 mm; 1 mm);
Corning Square cover glasses (18 mm×18 mm; Corning 285018); and
Hotplate or Oven.

Cartridge frames were 3D printed. Glass slides and glass cover slips were coated using fluorinated solution (Note: once glass is prepared, it can be re-used provided the hydrophobic properties are retained). In this example, the glass surfaces were plasma O2-treated at 100 W for 30 seconds, then immediately immersed in liquid silane solution (e.g., 5% v/v fluorinated silane in EtOH) for one hour at room temperature. The glass pieces were then rinsed with anhydrous EtOH, followed by DI water, followed by EtOH (3×). Finally, the samples were dried with compressed nitrogen and were heated in an oven at 60° C. overnight at ATM pressure.

A PDMS solution was then prepared. A 10:1 v/v ratio of monomer to crosslinker from PDMS kit was used. The solution was mixed very thoroughly (e.g., for approximately two minutes), and was degassed using the vacuum/desiccator chamber for approximately 20 minutes.

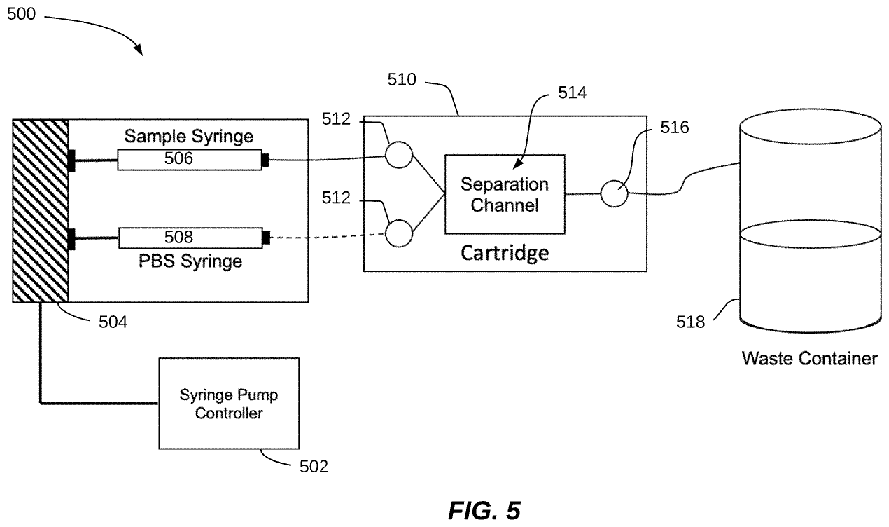

Referring now to FIG. 7, the glass slide was placed down into a petri dish, and cartridge frame was placed down on top of glass slide. The degassed PDMS mixture was then poured into the cartridge frame until the ledge is reached (shown as the red arrow). (Note: sufficient PDMS mixture was used to account for overflow into the petri dish). The mixture was poured gently so as to not generate bubbles. In the event bubbles were generated, the entire petri dish was degassed to remove them. The glass cover slip was placed on top so it rests on the ledge. The whole petri dish was placed in the oven (or the hotplate) at 58° C. overnight.

The glass cover slip was taken from the top. A scalpel was used to disconnect parts of PDMS where needed. The cartridge frame was taken out, now with the PDMS bottom portion attached thereto.

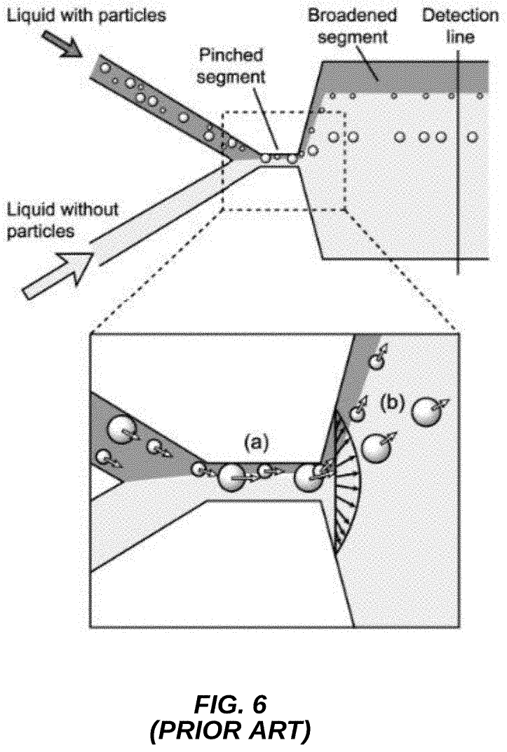

Third-party lithography services were used to create SU-8 molds (e.g., molds fabricated using SU-8 epoxy-based photoresist) on silicon wafers, e.g., following the steps shown in FIG. 4A. See also FIG. 8. The master wafer is reusable. The photoresist coating thickness corresponded to the height of the chamber (in the device shown above, the height is approximately 100 μm). The master wafer was placed into a petri dish, and PDMS mixture poured onto the device, to achieve a total PDMS height of about 500 μm. The entire petri dish was degassed again to ensure there are no small bubbles present. The PDMS was cured on petri dish at 60° C. overnight

The PDMS was then peeled from the master wafer. Holes were punched on the inlet and outlet of the top PDMS chamber, followed by O₂ plasma treatment of the PDMS pieces. The top PDMS piece was aligned to the bottom and pressed down gently to ensure good contact. The cartridge was left overnight at 60° C. to secure the PDMS bonding.

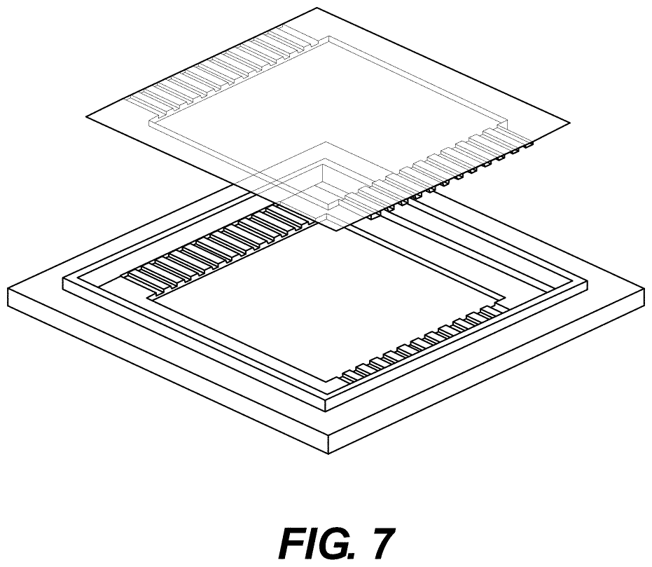

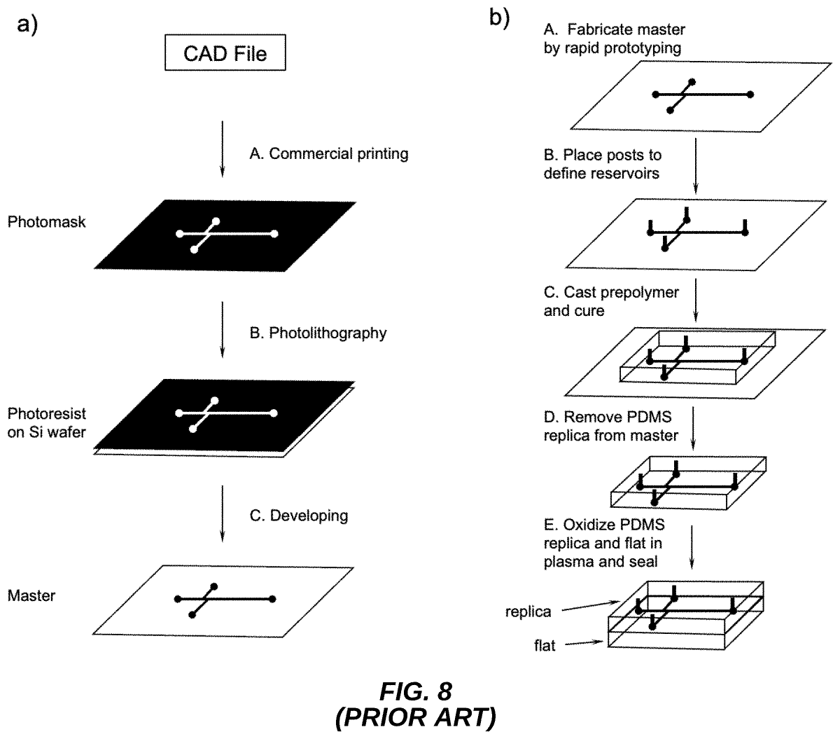

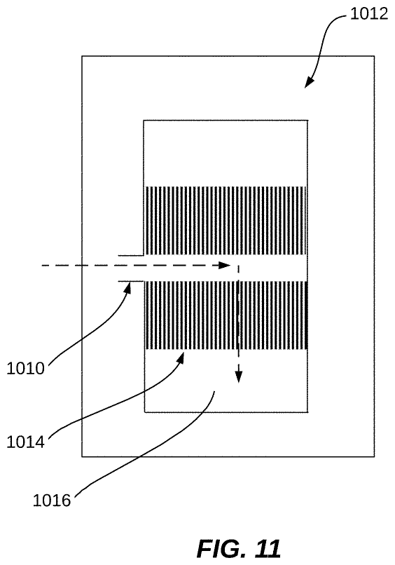

Referring to FIGS. 9 and 10, top perspective views of a cover plate 900 and a fluidics layer 1000, respectively, are illustrated. The cover plate 900 is configured to be assembled over the top of the fluidics layer 1000 to form a sample cartridge 1200 for use in an interferometry system as shown in FIG. 12. FIG. 12 shows the sample cartridge 1200 having a wireframe view of the cover plate 900 assembled over the fluidics layer 1000 such that alignment between various features on the cover plate and fluidics layer is visible. An alignment thru-hole 920 may be included on cover plate 900 such that when the cover plate 900 and fluidics layer 1000 are assembled correctly, certain parts of the fluidics layer 1000 (e.g., an imaging region 1012 or fine channels 1014) are at least partially visible therethrough. The fluidics layer 1000 may be formed from a material that is transparent and is a poor absorber of proteins. In some embodiments, the fluidics layer 1000 is formed from polymethyl methacrylate (“PMMA”), topaz, or polycarbonate. The cover plate 900 is also formed from a transparent material. For example, the cover plate 900 may be formed from glass.

The cover plate 900 includes fluid inlets 902 configured to receive a fluid (e.g., a sample fluid) into the assembled sample cartridge. In some embodiments, the sample fluid may be a diluted sample including whole blood, PBS, and an anticoagulant mix. The ratio of whole blood to PBS and anticoagulant may have an optimal range depending on the design and size of fluidics features within the sample cartridge. For example, as discussed above, it may be advantageous to keep the fluidics features, such as fluid channels and mixing regions, as shallow as possible so that cells are near a focal plane of the interferometry system. Diluting the whole blood collected from a patient to a desired ratio of whole blood to PBS and anticoagulant may help prevent blockages within the fluidics features. In some embodiments, a small jar or container having a desired amount of PBS and anticoagulant pre-loaded therein may include an indicator mark to show a user how much sample should be added to the jar to achieve the desired amount of sample dilution.

Sample fluid or diluted sample fluid may be introduced to one or more fluid inlets 902. In some embodiments, a sample holder 904 (e.g., an open-ended container such as a cylinder, tube, bowl, or other container) may surround one or more fluid inlets 902 and is configured to hold the volume of fluid sample. The sample holder 904 is configured to hold the sample fluid such that gravity pulls the fluid down and creates a hydraulic pressure in the fluid that helps to push the sample fluid from the sample holder into the inlets 902. The pressurized fluid then flows through the sample cartridge and imaging is performed on the flowing sample, as will be discussed in further detail herein. Using gravity to pressurize fluid and promote flow of the sample fluid through the cartridge may eliminate the need to include pumps in some embodiments.

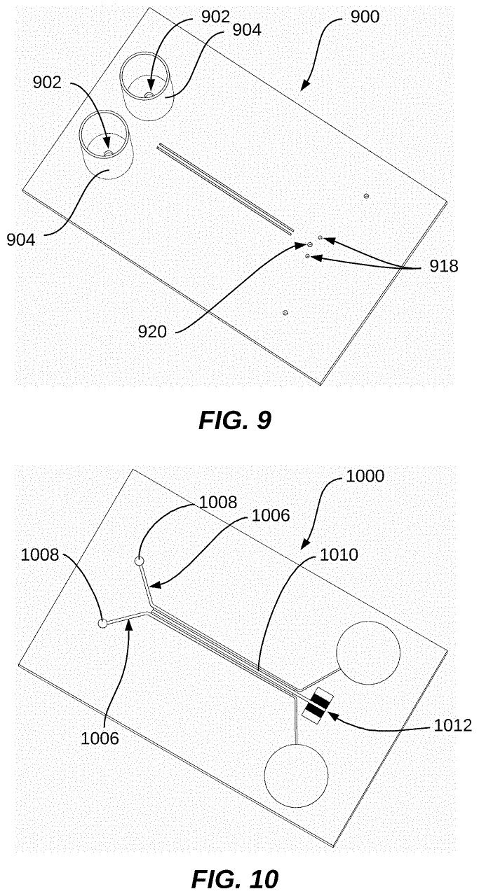

From each of the one or more fluid inlets 902, pressurized sample fluid (e.g., pressurized using passive gravity-based hydraulic pressure and/or using active pumping) flows into one or more fluid channels 1006 via openings 1008 disposed within the fluidics layer 1000. The openings 1008 are in fluid communication with the inlets 902 on cover plate 900. The fluid channels 1006 may fluidly communicate with a common mixing channel 1010 that directs sample fluid to an imaging region 1012. Referring to FIG. 11, a detailed view of the imaging region 1012 is illustrated having the mixing channel 1010 that directs fluid flow as indicated by the dashed arrow. From the mixing channel 1010, the fluid enters the imaging region 1012.

In some embodiments, a portion of the fluid is pushed through a plurality of fine channels 1014 toward one or more side chambers 1016. While not required, the fine channels 1014 may act as a filter by preventing large particles or cells within the sample fluid from reaching the side chambers 1016. For example, the fine channels 1014 may have a height and a width of approximately 12 mm such that particles or cells having a dimension larger than 12 mm (e.g., white blood cells “WBCs”) may be prevented from reaching the side chambers 1016. This filtering mechanism may assist with separation of cells for easier identification and differentiation during interferometry image processing. In embodiments that do not include a filtering mechanism, differentiation of cells may be accomplished using computer vision.

Referring to FIGS. 9, 10, and 12 together, the cover plate 900 includes two or more micropump ports 918. Once the sample cartridge 1200 is assembled, each micropump port 918 may be in fluid communication with the imaging region 1012. In embodiments wherein the fluidics layer 1000 has fine channels 1014 and side chambers 1016, each micropump port 918 may be in fluid communication with a side chamber 1016 in the imaging region 1012. A micropump (not shown) may connect to both micropump ports 918 via tubing and may circulate the sample through the imaging region while the interferometric imaging occurs. In some embodiments, the flow rate of the micropump may be less than approximately 50 cubic centimeters/minute to prevent damage to cells within the sample.

By performing imaging on the sample as it is circulating, more of the sample cells can be viewed and more data can be collected for analysis and diagnosis. This may be particularly advantageous when searching for abnormal cells that make up a relatively low percentage of a patient's cells. For example, in patients with malaria, very few red blood cells may carry the parasite. Thus, many red blood cells must be imaged to detect the parasite. Imaging the flowing sample instead of imaging a smear or other static sample may significantly decrease the amount of time required to image a large number of cells. Furthermore, because all cells in a flowing sample may be imaged as they pass through an optical path of the interferometry system, a lower volume of fluid may be collected from the patient compared to current procedures using a static sample. For example, only a finger prick and between 1-24, of blood from the patient may be needed in the flowing system facilitated by the disclosed sample cartridge. By comparison, the current imaging process which may require multiple sample smears on multiple slides for imaging, typically requires collection of a much larger volume of blood from the patient using a much larger needle and often a tourniquet.

Moreover, because traditional systems do not make use of computer vision and machine learning programs to identify and differentiate different types of healthy and unhealthy components within a sample (e.g., red blood cells, white blood cells, platelets), the components of a sample must be sorted prior to imaging. The sorting process is generally time-intensive and requires access to lab equipment and supplies (e.g., large needles to collect samples, ethylenediaminetetraacetic acid “EDTA” tubes, Ficoll, a conical tube, a centrifuge, PBS, syringes, male Luer fluid connectors, silicone tubing, waste containers, etc.). Additionally, the separating process must be performed by a trained professional. Thus, the current imaging process is not suited for use in low-resource areas where lab equipment and trained professionals are scarce. Furthermore, because the sorting process takes generally at least 40 minutes just to prepare a sample for imaging, throughput using this method is very low.

With the disclosed sample cartridges and computer vision-assisted image processing, the entire process of pre-sorting cells may be eliminated. This drastically simplifies complexity of the imaging process, reduces the number of required supplies, reduces cost associated with imaging, reduces amount of time needed to obtain imaging results, and does not require a trained professional to perform various steps associated with pre-sorting a sample. The computer vision portion of image processing may use the interferometry images collected on the flowing sample to obtain information about components (e.g., red blood cells, white blood cells, platelets, etc.) within the sample. For example, information about red blood cell shape, membrane flexibility, sickle features, percentage of sickling, and other parameters may be collected. The images may also be used to identify other morphological changes to cells that are indicative of different types of diseases, such as sickle cell anemia or malaria.

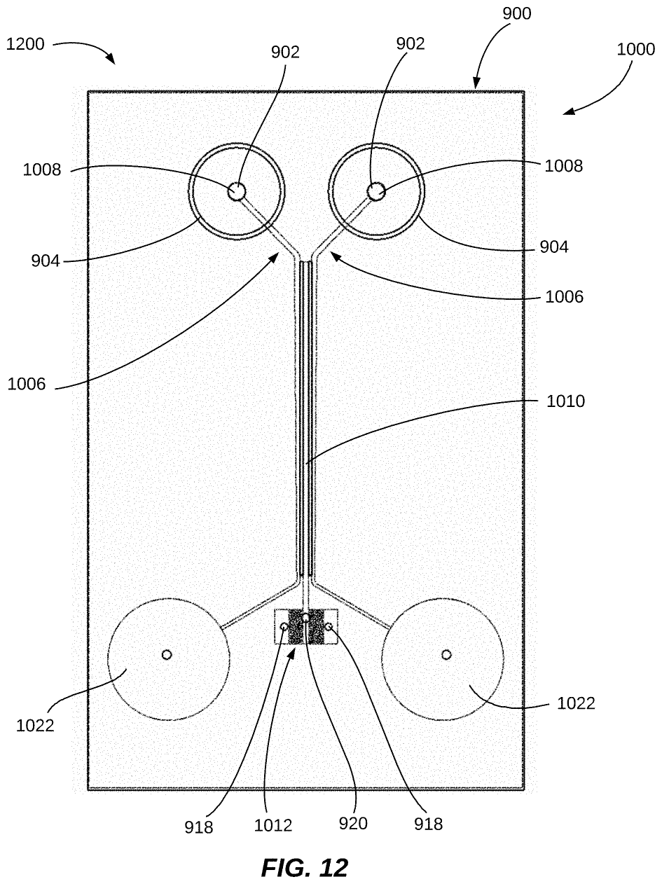

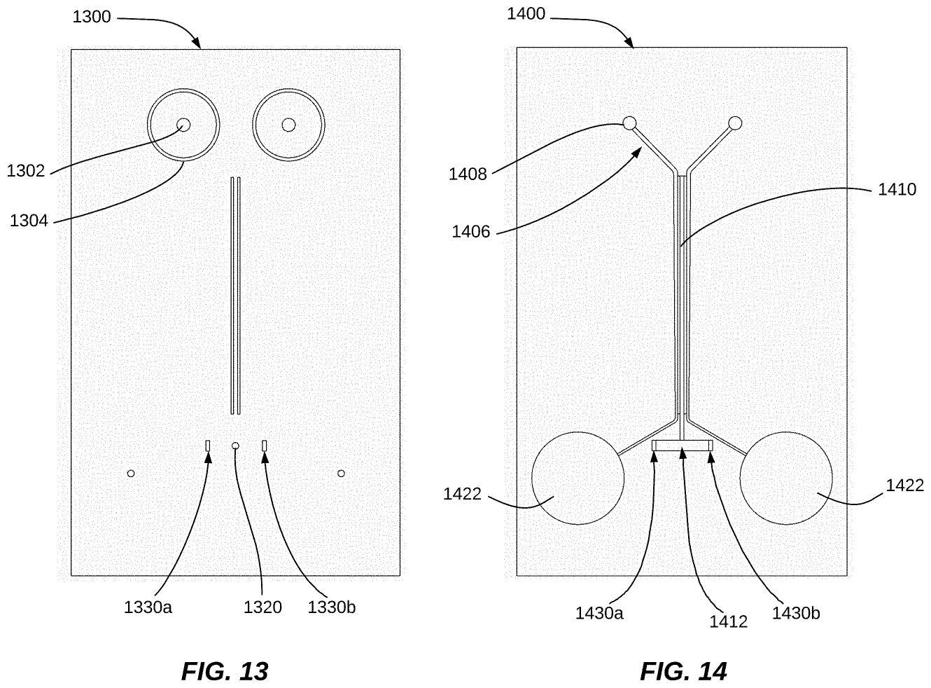

FIGS. 13 and 14 illustrate alternative embodiments of a cover plate 1300 and fluidics layer 1400, respectively, that may be assembled into a sample cartridge to provide the advantages described above. The cover plate 1300 is configured to be assembled over the fluidics layer 1400. The fluidics layer 1400 may include at least some of the same features (e.g., inlets 1302, sample holders 1304, an alignment thru-hole 1320, etc.) as described with respect to fluidics layer 1000. The cover plate 1330 may include at least some of the same features (e.g., openings 1408, fluid channels 1406, common mixing channel 1410, an imaging region 1412, reservoirs 1422, etc.) as described with respect to cover plate 900; however, additional features may be present. For example, fluidics layer 1400 may include electrodes 1430a, 1430b to assist with imaging different parts of a sample or performing imaging on a sample under charged conditions. The first electrode 1430a disposed on a first side (e.g., a left side) of the fluidics layer 1400 may be a ground electrode and the second electrode 1430b disposed on a second side (e.g., a right side) of the fluidics layer 1400 may be a positive electrode. In some embodiments, the cover plate 1300 may include corresponding thru-holes 1330a, 1330b to allow lead access between a voltage source (not shown) and the underlying electrodes 1440a, 1440b. While the electrodes are shown on opposing sides of the imaging region 1412 (e.g., to the left and right sides of the imaging region 1412), one of skill in the art will appreciate that other electrode positions and configurations can be used without departing from the scope of the present disclosure. Additionally, while micropump ports are not illustrated in cover plate 1300, such features may be added to keep sample flowing through the imaging region 1412 during imaging.

Direct current voltage may be applied to the sample cartridge via the electrodes using a voltage source (not shown) to perform electrophoresis on the sample fluid within the sample cartridge. In some embodiments, the voltage applied may be between approximately 0.2V and approximately 5V. The voltage applied may be determined as a function of the pH level and contents of the sample being directed through fluid channels in the fluidics layer. For example, whole blood having red blood cells that have been broken apart (e.g., by a lysing reagent prior to entering the sample cartridge) such that hemoglobin contained therein is released from the RBCs and may be imaged. In some embodiments, the fluidic layer 1400 in sample cartridge may include one or more filter membranes (not shown) and/or fine channels (e.g., similar to fine channels 1014 in fluidics layer 1000) to prevent lysed RBC fragments and other debris from entering an imaging region while allowing hemoglobin to pass through. When voltage is applied to the fluidics layer 1400, the hemoglobin may separate into bands within the imaging region 1412. The bands, rather than individual cells or components, are imaged using a high-resolution interferometry system. The high-resolution imaging system may capture data (e.g., hemoglobin separation under voltage charged conditions) that can be analyzed for making diagnostic predictions.

While the example described above includes the step of lysing RBCs in a sample prior to introducing the sample to the cartridge, this step is not required. In alternative embodiments, a cellulose acetate (CA) membrane embedded with ammonium chloride (NH₄Cl) and potassium bicarbonate (KHCO₃) in part of the cartridge 1300 that is exposed to the sample. This membrane may break down RBCs after the unprocessed sample is introduced to the cartridge, thereby eliminating the need for a professional to perform a separate sample lysing step.

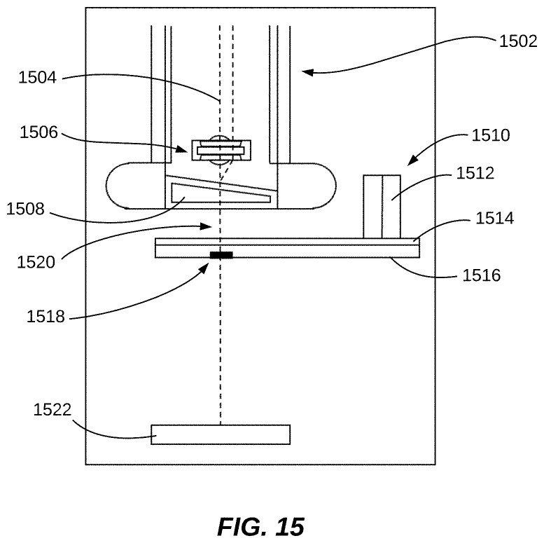

The various sample cartridges described above provide cost, time, resource, and complexity savings with respect to current sample handling techniques. Additional advantages can be realized when the sample cartridges are used with an interferometry system having a cartridge holding slot. Such a system is illustrated in FIG. 15. An interferometry system 1502 includes various optical components, light sources, and sensors similar to those discussed with respect to FIGS. 2A-2C. The system 1502 generates a beam of light 1504 that is directed through various optical elements represented by element 1506 toward a sample. In some embodiments, an angled element 1508, such as an angled prism, triangular prism, or angled cover slip, is included within the interferometry system 1502. The angled element 1508 reflects a first portion of the light beam 1504 as a reference beam. The angled element 1508 allows a second portion of the light beam 1504 to transmit through where the light encounters the sample cartridge 1510. The sample cartridge 1510 may include one or more sample holders 1512 disposed on a cover plate 1514, wherein the cover plate 1514 is assembled over a fluidics layer 1516 as shown. The fluidics layer 1516 includes an imaging region 1518 that is aligned along a light path 1520 of the second portion of the light beam 1504. Light that passes through the sample contained within the imaging region 1518 (e.g., a sample fluid that is moving and flowing using passive or active fluid pressure) may impinge upon a reflective element. The reflective element may be a separate reflective element 1522; however, in some embodiments, the reflective element may be a mirrored coating applied to a bottom side of the cartridge using adhesives, metal deposition, or other fabrication and assembly processes. The reflective element reflects light toward a sensor (not shown) contained within the interferometry system 1502 for data image capture.

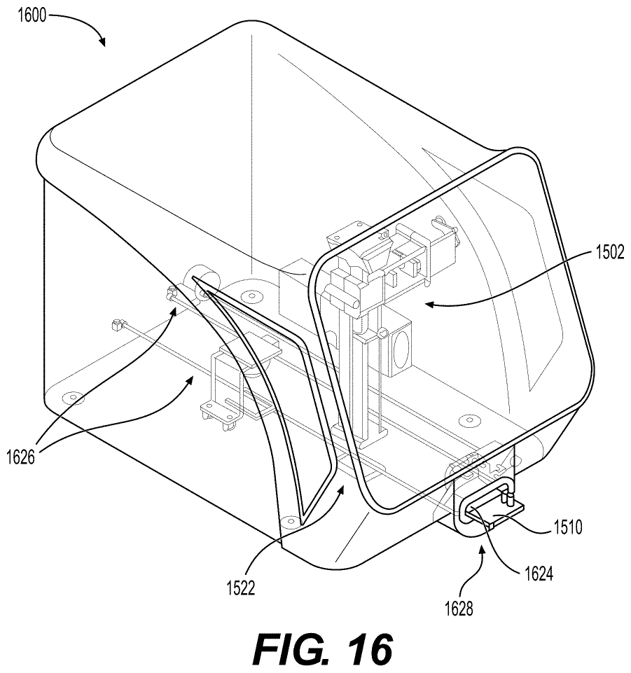

FIG. 16 shows a wireframe view of a complete imaging system 1600 that includes the interferometry system 1502, the sample cartridge 1510 loaded onto a cartridge holder 1624, and the reflective element 1522. The cartridge holder 1624 may include geometry to hold the sample cartridge 1510 securely therein. For example, the cartridge holder 1624 may include slots, slides, glides, stops, clips, tabs, or other features configured to lock onto or around the sample cartridge to achieve a removable mechanical lock and/or a friction fit. In the system 1600, the cartridge holder 1624 may be movably mounted on rails 1626. Once the sample is loaded into the cartridge holder 1624 at a housing opening 1628, the cartridge holder and the sample cartridge may be moved along the rails until an imaging portion of the sample cartridge is aligned along the optical path of the interferometer light beam as discussed with respect to FIG. 15. When the imaging process is completed, the cartridge holder and sample cartridge may be moved along the rails toward the housing opening 1628 for removal. In some embodiments, the movement of the cartridge holder may be initiated by an on/off button or other user input. In some embodiments, the system 1600 further includes a power source such that sample cartridges having electrodes thereon may receive electric current from the power source and may be imaged under electrically charged conditions. The system 1600 further includes a printed circuit board to process images obtained from the sample and includes a user interface (e.g., a screen) on which results of the image processing and analysis may be presented to a user. The system may further include a battery, wireless communications (e.g., WiFi and/or Bluetooth) capability, and/or wired communication capability.

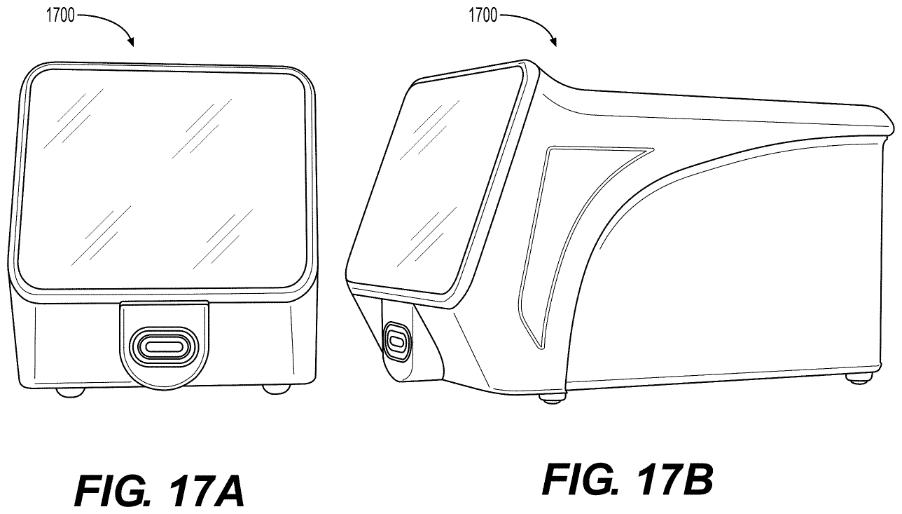

FIGS. 17A-17B illustrate front and side perspective views of a housing 1700 of a complete imaging system such as the system 1600 discussed with respect to FIG. 16.

As discussed above, the image analysis and diagnostic aspects of the present system may be further refined and improved by implementing machine learning in the software used in identifying target objects, such as a sickled red blood cell in the case of sickle cell disease diagnostics. The image analysis and recognition software used in the diagnostics may be trained using training sets prior to installation on the imaging system, and improved software may be uploaded to the imaging system as further refinements are made in the machine learning training sets and resulting software.

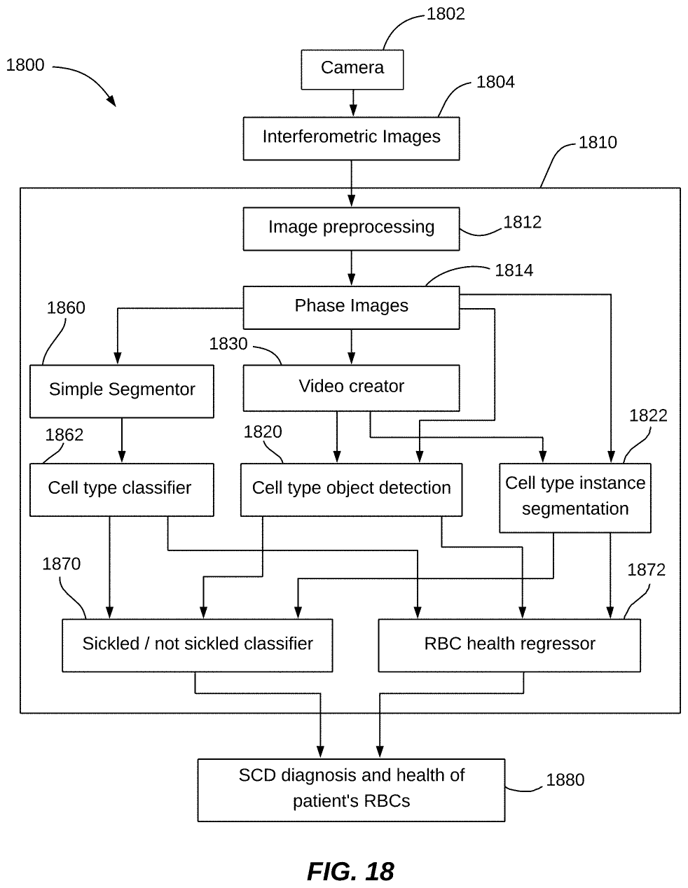

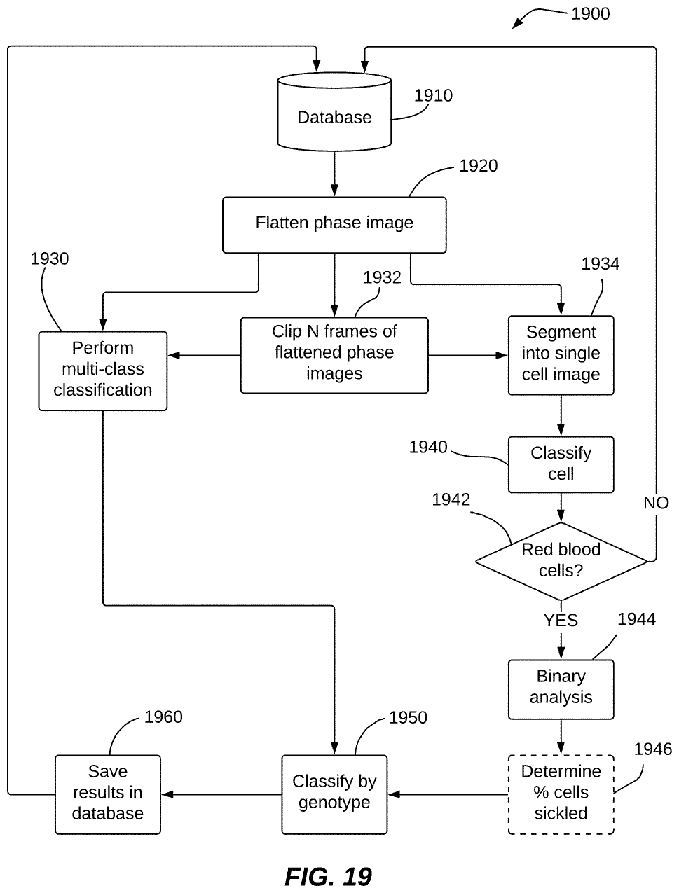

FIGS. 18 and 19 illustrate exemplary machine learning processes for sickle cell anemia diagnostics using image processing. It is noted that, while the present disclosure uses the diagnosis of sickle cell disease as the implementation example, the details of the image recognition and diagnostics processes may be adapted to the image-based diagnosis of diseases other than sickle cell disease.

In particular, the convolutional neural network aspects of the image recognition and diagnostic software may be trained to efficiently and automatically recognize sickled RBCs or other diseases using training sets including interferometric images of sickled and healthy RBCs. For instance, the training inputs may include interferometric images of whole blood samples (e.g., processed with a saline solution for dilution) and known sickle cell disease diagnosis of those processed samples. The outputs from the training process may include, for instance, automated SCD diagnosis, an index of the health of a patient's RBCs, and trained neural network models that may be implemented in the software used with the imaging systems described above.

Referring to FIG. 18, an exemplary training system is described. A training system 1800 utilizes a camera 1802 to obtain interferometric images 1804 of target objects, such as RBCs. Interferometric images 1804 are fed into a training unit 1810.

Within training unit 1810, training system 1800 includes an image preprocessing unit 1812 for pre-processing interferometric images 1804. In image preprocessing unit 1812, a variety of processes may be implemented such as Fourier transform and/or inverse Fourier transform to extract phase images 1814 from interferometric images 1804, phase unwrapping, and image flattening.

Phase images 1814 may be processed in a variety of ways within training unit 1810. For example, each one of phase images 1814, with each image possibly containing multiple types of cells, may be directly processed by a cell type object detection block 1820, which draws a bounding box around each cell found in the image, classifying each cell into a cell type, such as a white blood cell (WBC), RBC, or a platelet. Alternatively, each one of phase images 1814 may be processed by a cell type instance segmentation block 1822, which labels each of the pixels within the phase image with the cell to which the pixel belongs, along with the cell type corresponding to that pixel. In an alternative process, a short video of phase images 1814 (e.g., of a few frames of the phase images or longer time frames) is created in a video creator block 1830. The short video may then be processed by cell type object detection block 1820 and/or cell type instance segmentation block 1822. As a further alternative, phase images 1814 may be processed by a simple segmentor 1860, which extracts images of cells from their background using, for example, threshold segmentation. Then, the images of cells so segmented may be processed by a cell type classifier block 1862, which identifies images of RBCs.

The results of cell type object detection block 1820, cell type instance segmentation block 1822, and cell type classifier 1862 may then be processed by a sickled/not sickled classifier block 1870 for determining whether each RBC identified is sickled or not. Alternatively or in addition, a RBC health regressor block 1872 may be used to determine the relative health (i.e., analyses beyond sickle cell disease) of the identified RBC. For example, an identified RBC may not be sickled yet be affected by another condition. Thus, in some embodiments, RBC health regressor block 1872 may be used to determine the relative health of an RBC that is not necessarily identified as sickled. Additional analyses of the identified RBCs may be performed, such as analyzing the cell membrane flexibility of the identified RBC based on a review of the short video of phase images as generated with video creator block 1830. The “ground truth” to be used as the training basis for the analysis performed by sickled/not sickled classifier block 1870 and RBC health regressor 1872 may be obtained from, for example, manual analysis and diagnosis of sickle cell disease patients' blood by a trained cytologist. Additionally, purposely distressed RBC samples (e.g., RBCs treated with various levels of a stressing agent such as sodium metabisulfite) can also allow training of regression models that provide a quantitative index of the health of the analyzed RBCs at RBC health regressor 1872. Finally, the results of the SCD diagnosis and health of the analyzed RBCs may be provided to the user in a step 1880.

It is noted that similar training methods may be used to refine the machine learning processes for the diagnosis of other conditions, such as malaria. By providing training unit 1810 with image parameters specific to the diagnosis of other diseases such as malaria and other blood infecting pathogens. Training unit 1810 may be further modified to perform analysis of other components of whole blood samples, such as WBC counts and platelet health, by providing different classifier and segmentation blocks specific to those blood components. Similarly, training unit 1810 may be configured for learning to diagnose diseases that may be detectable by analysis other samples, such as urine or saliva.

An alternative method for training the machine learning algorithms used for SCD diagnosis is illustrated in FIG. 19. A process 1900 is used in refining a database 1910 containing the training sets for use in SCD diagnosis. When a phase image is provided to database 1910, the phase image is flattened in a step 1920 for uniformity of the image in the analysis. The flattened phase image may be processed, for example, in a step 1930 to perform multi-class classification to identify the different cells captured in the phase image, such as RBCs, WBCs, and platelets. Alternatively, multiple flattened phase images may be clipped together in a step 1932 as short video clips for adding a temporal component to the image analysis. The clipped images may then be classified in step 1930, or sent to a step 1934 to segment the phase images into smaller images, each one of the images containing a single cell image. Alternatively, the flattened phase image from step 1920 may be directly sent to step 1934 for image segmentation.

Continuing to refer to FIG. 19, segment step 1934 may be followed by a step 1940 to classify the cell type of the single cell image. If a determination 1942 determines no red blood cells are present in the single cell image from step 1934, then process 1900 returns the result to database 1910. If determination 1942 determines there are red blood cells in the single cell image, then a binary analysis is performed in a step 1944 to determine whether or not the identified RBC is sickled or not. In an optional step 1946, a determination of the percentage or sickled cell in a given image or sample is made. For example, step 1946 may be performed once a certain threshold number of phase images have been analyzed to improve statistical significance of the analysis.

Following steps 1930 and 1946, process 1900 proceeds to a step 1950 in which the analyzed phase images are processed to determine the sample classification by genotype. For example, SCD may present in a variety of different forms (e.g., hemoglobin SS, hemoglobin SC, hemoglobin SB+, etc.) and each form may be differentiated and classified using the imaging system and machine learning processes described herein. In some embodiments, differentiating between certain sickle cell genotypes may alternatively or additionally require the use of additional sample processing (e.g., electrophoresis) and/or imaging techniques (e.g., imaging and analysis of hemoglobin bands in a sample after additional sample processing). Finally, the analysis results are saved in database 1910 in a step 1960, and the process is repeated using different phase images that are specifically relevant to the disease being diagnosed.

Methods and systems of the present disclosure are advantageous to provide affordable and easy to use interferometry for diagnosis and monitoring of red blood cell diseases. These systems and methods do not require skilled personnel and are a platform technology, with the potential of being applied to multiple disease states in the blood. Setup is very simple and can be used in very low resource settings. The user experience is also simple and does not involve more than 3 steps. The process is label-free and therefore does not utilize staining. Additionally, no biological reagents are used.

As discussed above, the systems and methods of the present disclosure reduce measurement errors in the phase profile associated with instability in the interferometric system, including differential vibrations or air perturbations in the interferometer arms. Thus, the systems can be used in ambient conditions in very low-resource settings, where vibration-isolating optical tables are inaccessible.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

1. An imaging system for imaging a fluid sample, the system comprising:
a light source configured to generate a beam of light;
an angled element disposed along an optical path of the beam of light;
a sample cartridge holder configured to receive a sample cartridge and configured to hold the sample cartridge in a first position in which an imaging region of the sample cartridge is disposed along the optical path; and
a sensor configured to capture the beam of light after the beam of light passes through the angled element and the imaging region of the sample cartridge,
wherein the imaging region of the sample cartridge is configured to receive the sample fluid.

2. The system of claim 1, wherein the angled element is disposed between the light source and the sample cartridge.

3. The system of claim 1, further comprising a reflector, wherein the sample cartridge is disposed between the light source and the reflector.

4. The system of claim 1, wherein the sample cartridge is disposed between the light source and the sensor.

5. The system of claim 1, wherein the sample cartridge holder is movable relative to the light source.

6. The system of claim 5, wherein the sample cartridge holder is configured to move between the first position and a second position in which the sample cartridge is outside of an imaging system housing.

7. The system of claim 1, wherein the sample cartridge comprises a fluidics layer and a cover plate disposed over the fluidics layer.

8. The system of claim 7, wherein the imaging region is disposed within the fluidics layer and wherein the cover plate comprises a sample fluid inlet in fluid communication with the imaging region.

9. The system of claim 7, further comprising a sample holder in fluid communication with the sample fluid inlet, wherein the sample holder is configured to receive and hold a volume of the fluid sample.

10. The system of claim 9, wherein a hydrostatic pressure in the volume of the fluid sample within the sample holder is configured to promote passive flow of the fluid sample into and through the imaging region.

11. The system of claim 8, further comprising a pump inlet port and a pump outlet port in fluid communication with the imaging region, wherein a pump is fluidly coupled with the pump inlet port and the pump outlet port and is configured to circulate the sample fluid within the imaging region.

12. A sample cartridge comprising:
a cover plate comprising a sample fluid inlet; and
a fluidics layer comprising:
an opening configured to receive a whole blood sample from the sample fluid inlet; and
an imaging region configured to receive the whole blood sample from the opening through a fluid channel,
wherein the sample fluid inlet, the opening, the fluid channel, and the imaging region are configured to promote a directional flow of the whole blood sample through the imaging region.

13. The sample cartridge of claim 12, wherein the imaging region further comprises a plurality of fine channels.

14. The sample cartridge of claim 12, wherein the imaging region further comprises a filter membrane.

15. The sample cartridge of claim 12, wherein the cover plate further comprises a pump inlet port and a pump outlet port in fluid communication with the imaging region.
